(19) United States
(12) Patent Application Publication
(10) Pub. No.: US 2014/0071671 A1
(43) Pub. Date: Mar. 13, 2014

(54) T-BAR LAMP

(71) Applicants: Tzyy-Jang Tseng, Hsinchu (TW); Yung-Cheng Sung, Hsinchu City (TW); Wen-Peng Shen, Hsinchu (TW)

(72) Inventors: Tzyy-Jang Tseng, Hsinchu (TW); Yung-Cheng Sung, Hsinchu City (TW); Wen-Peng Shen, Hsinchu (TW)

(73) Assignee: APM COMMUNICATION, INC., Hsinchu (TW)

(21) Appl. No.: 13/742,356

(22) Filed: Jan. 16, 2013

(30) Foreign Application Priority Data
Sep. 7, 2012 (TW) 101132859

(51) Int. Cl. F21V 21/03

(52) U.S. Cl. CPC F21V 21/03
USPC 362/235; 362/249.01

(57) ABSTRACT

A T-bar lamp includes a T-bar lamp housing, at least one light source, and a pattern. The T-bar lamp housing has an opening. The light source is mounted in the T-bar lamp housing. The pattern covers the opening and has at least one transparent region. The transparent region exposes the corresponding light source.

### CROSS-REFERENCE TO RELATED APPLICATION

This application claims the priority benefit of Taiwan application serial no. 101132859, filed on Sep. 7, 2012. The entirety of the above-mentioned patent application is hereby incorporated by reference herein and made a part of this specification.

### BACKGROUND OF THE INVENTION

1. Field of the Invention

The invention relates to a lamp. Particularly, the invention relates to a T-bar lamp.

2. Description of Related Art

Recently, in pursuit of simple and artistic interior design (especially office interior design), T-bars ceiling are often installed on top of indoor space, and a plurality of T-bar lamp with fixed light sources may be installed on the T-bar ceiling. Since the T-bar may be formed by rolling aluminum alloy and has a light, reinforced, and standardized scarf joint structure, the process of constructing and decorating the ceiling may be rapidly performed, and the relevant costs may be reduced. This results in the popularity of the T-bar ceiling. The normal indoor illumination is often accomplished by installing lamps on the ceiling panel, and T-bar lamps have been developed and manufactured for T-bar ceilings.

In the commonly known T-bar lamps, fluorescent light tubes often serve as the light sources for illumination. However, with the advancement of illumination technologies, light-emitting diodes (LED) have gradually replaced the fluorescent light tubes as the light sources of lamps. The LED is characterized by advantages of low power consumption, long lifetime, environmental protection, fast activation speed, compactness, and so on. Besides, the maturity of LED technologies leads to the enhanced power of the LED. At present, the LED has been applied for normal illuminative purposes in replacement of the fluorescent light tubes, and thus the T-bar lamp tends to employ the LED as the light source.

When the T-bar lamp is mounted on the T-bar ceiling, however, the T-bar lamp is exposed by the T-bar ceiling and thus brings about a perceivable appearance defect in comparison with other parts of the T-bar ceiling. As a result, if a number of T-bar lamps are installed on the T-bar ceiling, the T-bar lamps may ruin the overall artistic interior design.

### SUMMARY OF THE INVENTION

The invention is directed to a T-bar lamp with favorable decorative properties.

In an embodiment of the invention, a T-bar lamp that includes a T-bar lamp housing, at least one light source, and a pattern is provided. The T-bar lamp housing has an opening. The light source is mounted in the T-bar lamp housing. The pattern covers the opening and has at least one transparent region. The transparent region exposes the corresponding light source.

According to an embodiment of the invention, the T-bar lamp further includes a diffusion plate that is disposed on the T-bar lamp housing, and covers the opening. The pattern is disposed on the diffusion plate.

According to an embodiment of the invention, the pattern is disposed on the diffusion plate through printing or adhesion, for instance.

According to an embodiment of the invention, a material of the diffusion plate includes a combination of diffusion particles and polystyrene (PS), polycarbonate (PC), or polymethyl methacrylate (PMMA), for instance.

According to an embodiment of the invention, the T-bar lamp further includes a transparent plate that is disposed on the T-bar lamp housing. The pattern is disposed on the transparent plate.

According to an embodiment of the invention, the pattern is disposed on the transparent plate through printing or adhesion, for instance.

According to an embodiment of the invention, a material of the transparent plate includes PS, PC, or PMMA, for instance.

According to an embodiment of the invention, the pattern may be a non-transparent plate, and the non-transparent plate has at least one hollow region as the at least one transparent region.

According to an embodiment of the invention, the non-transparent plate includes an aluminum plate or a wooden plate, for instance.

According to an embodiment of the invention, the light source includes an LED lamp, a fluorescent lamp, or an incandescent lamp, for instance.

According to an embodiment of the invention, the pattern may be a transparent plate, and the transparent plate has at least one hollow region as the at least one transparent region.

According to an embodiment of the invention, the transparent plate has color.

In view of the above, the pattern covers the opening of the T-bar lamp housing of the T-bar lamp, and the transparent region of the pattern exposes the corresponding light source. Hence, the ornamentality of T-bar lamp may be effectively improved by the pattern.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an exploded view illustrating a T-bar lamp according to a first embodiment of the invention.

FIG. 2 is an exploded view illustrating a T-bar lamp according to a second embodiment of the invention.

FIG. 3 is an exploded view illustrating a T-bar lamp according to a third embodiment of the invention.

FIG. 4 is an exploded view illustrating a T-bar lamp according to a fourth embodiment of the invention.

### DESCRIPTION OF EMBODIMENTS

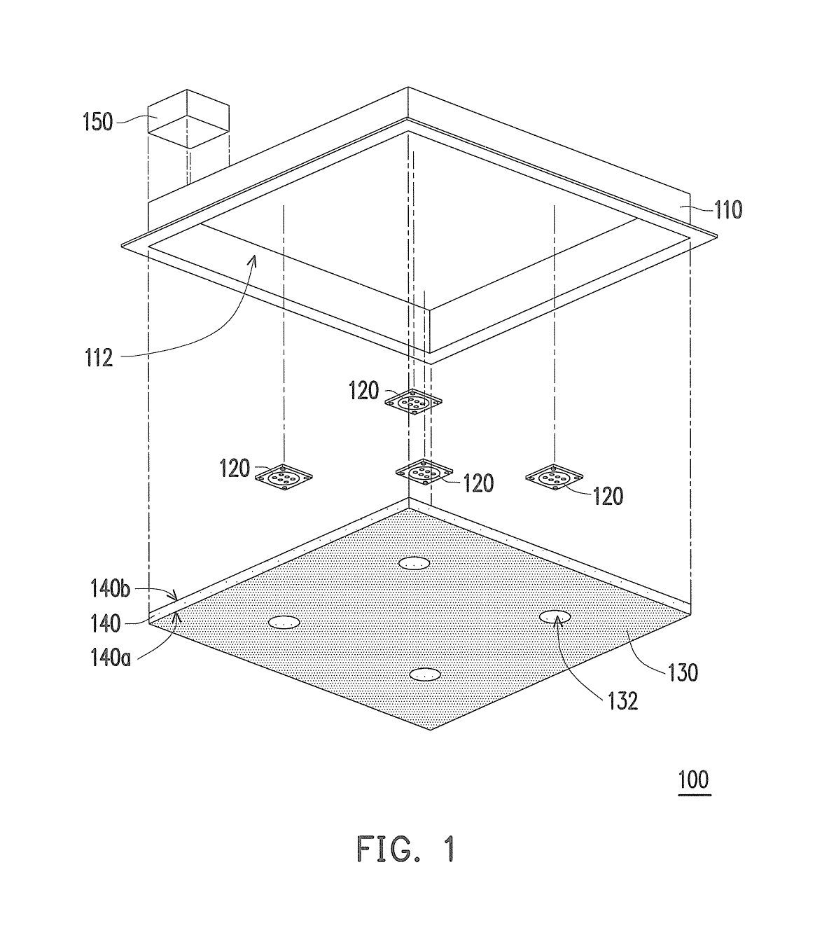

FIG. 1 is an exploded view illustrating a T-bar lamp according to a first embodiment of the invention.

With reference to FIG. 1, the T-bar lamp 100 includes a T-bar lamp housing 110, at least one light source 120, and a pattern 130. The T-bar lamp housing 110 has an opening 112. The dimension of the T-bar lamp housing 110 ranges from 59.5 cm×59.5 cm to 60.5 cm×60.5 cm, for instance.

The light source 120 is mounted in the T-bar lamp housing 110. The T-bar lamp housing 110 described herein has four light sources 120, for instance, which should however not be construed as a limitation to the invention. As long as the T-bar lamp housing 110 has at least one light source 120, the T-bar lamp housing 110 falls within the scope of the invention.

In the present embodiment, the light sources 120 are LED lamps, for instance, and the types of the LED lamps may be chip-on-board (COB) type LED lamps, surface-mount-technology (SMT) type LED lamps, or other types of LED lamps. This should not be construed as a limitation to the invention. Besides, in other embodiments, the light source may also be a fluorescent lamp or an incandescent lamp, and the type of the light source is not limited in the invention.

The pattern 130 covers the opening 112 and has at least one transparent region 132, and the transparent region 132 exposes the corresponding light source 120. Hence, in the present embodiment, the pattern 130 has four transparent regions 132, each of which respectively corresponds to one of the four light sources 120; however, the invention is not limited thereto. People having ordinary skill in the pertinent art may, according to the actual design requirements, adjust the number and the locations of the transparent regions 132.

In addition, according to the present embodiment, the transparent region 132 is shaped as a circle, for instance, while the transparent region 132 in other embodiments may have a decorative shape, such as a square, a heart or a cloud. A user may, based on actual design requirements, change the shape of the transparent region 132 to enhance the ornamentality of the T-bar lamp 100, which should not be construed as a limitation to the invention.

The T-bar lamp 100 described in the present embodiment may selectively include a diffusion plate 140. Here, the diffusion plate 140 is disposed on the T-bar lamp housing 110 and covers the opening 112, and the pattern 130 is disposed on the diffusion plate 140. A material of the diffusion plate 140 includes a combination of diffusion particles and polystyrene (PS), polycarbonate (PC), or polymethyl methacrylate (PMMA), for instance. The diffusion plate 140 is transparent, and light from the light sources 120 is diffused by the diffusion plate 140 and then emitted. Hence, the arrangement of the diffusion plate 140 on the T-bar lamp housing 110 softens the light and avoids the glare.

In another aspect, the diffusion plate 140 has a light-emitting surface 140a and a light-incident surface 140b. The pattern 130 may be disposed on the light-emitting surface 140a or the light-incident surface 140b of the diffusion plate 140. According to the present embodiment, the pattern 130 is exemplarily arranged on the light-emitting surface 140a of the diffusion plate 140. The pattern 130 may be transparent or non-transparent and may have color; in other embodiments of the invention, the pattern 130 may also have a decorative design, which should not be construed as a limitation to the invention. A material of the pattern 130 is, for instance, a printing material (e.g., printing ink, carbon powder, a coating material, etc.) or an adhesive material. Here, the pattern 130 is disposed on the diffusion plate 140 through printing or adhesion, for instance.

On the other hand, the T-bar lamp 100 described in the present embodiment may selectively include a power module 150. The power module 150 is disposed on the T-bar lamp housing 110 for supplying power to the light sources 120. When the light sources 120 are LED lamps, the power module 150 is an AC-DC inverter, for instance.

As described in the previous embodiment, the pattern 130 is disposed on the diffusion plate 140, such that the transparent regions 132 of the pattern 130 expose the corresponding light sources 120. Through the light that is emitted from the light sources 120 and passes through the transparent regions 132, the light sources 120 may equip the T-bar lamp 100 with the illumination function; other parts of the light may be blocked by the pattern 130, and thus may have reduced brightness or may encounter a color change. Since the material and the color of the pattern 130 may be adjusted according to the actual requirements, favorable ornamentality of the T-bar lamp 100 may be guaranteed.

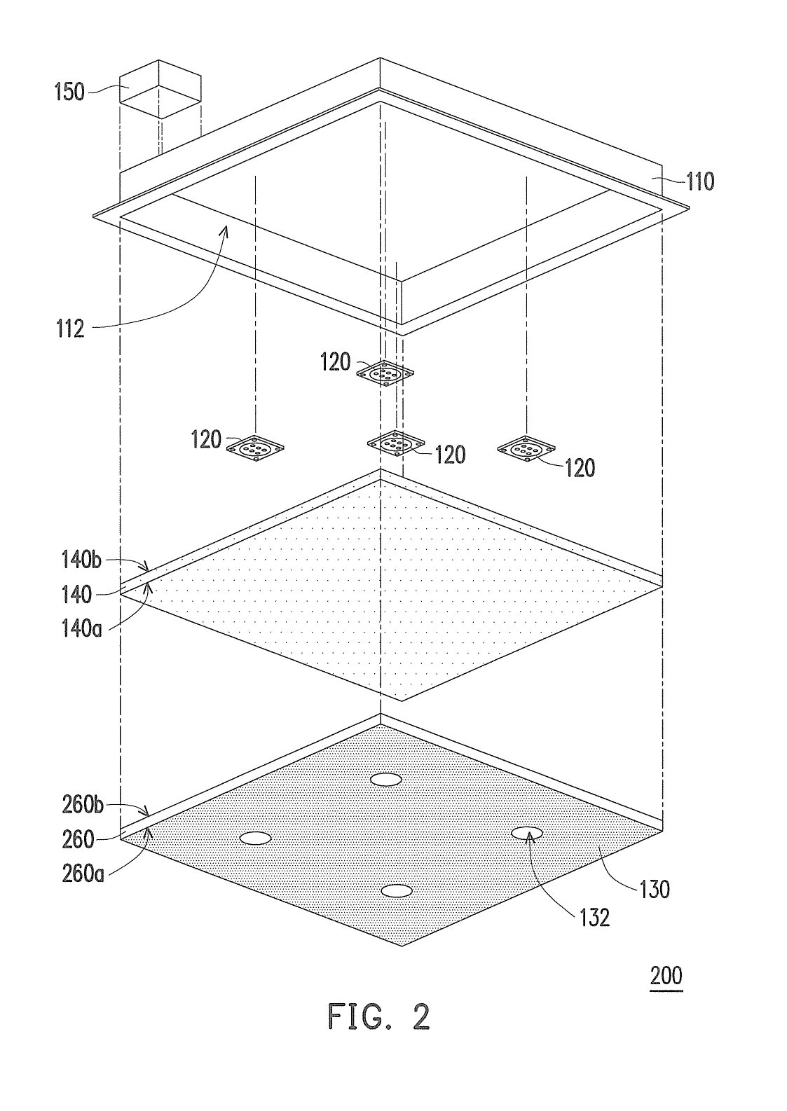

FIG. 2 is an exploded view illustrating a T-bar lamp according to a second embodiment of the invention.

With reference to FIG. 1 and FIG. 2, the difference between the T-bar lamp 200 and the T-bar lamp 100 lies in that the T-bar lamp 200 further includes a transparent plate 260. Components of the T-bar lamp 200 similar to those of the T-bar lamp 100 depicted in FIG. 1 are represented by the same reference numbers, are made of similar materials through performing similar processes, and have similar materials, arrangements, and effects; therefore, the similarities of the T-bar lamp 200 and the T-bar lamp 100 will not be further explained hereinafter. The difference between the T-bar lamp 200 and the T-bar lamp 100 will be described hereinafter.

In the present embodiment, the transparent plate 260 is disposed on the T-bar lamp housing 110 and covers the opening 112, and the pattern 130 is disposed on the transparent plate 260. A material of the transparent plate 260 is PS, PC, or PMMA, for instance, and therefore the transparent plate 260 allows light passage.

In another aspect, the transparent plate 260 has a light-emitting surface 260a and a light-incident surface 260b. The pattern 130 may be disposed on the light-emitting surface 260a or the light-incident surface 260b of the transparent plate 260. According to the present embodiment, the pattern 130 is exemplarily arranged on the light-emitting surface 260a of the transparent plate 260. The pattern 130 may be transparent or non-transparent and may have color; in other embodiments of the invention, the pattern 130 may also have a decorative design, which should not be construed as a limitation to the invention. A material of the pattern 130 is, for instance, a printing material (e.g., printing ink, carbon powder, a coating material, etc.) or an adhesive material. Here, the pattern 130 is disposed on the transparent plate 260 through printing or adhesion, for instance.

The transparent plate 260 may be disposed on a side of the light-emitting surface 140a or the light-incident surface 140b of the diffusion plate 140. According to the present embodiment, the transparent plate 260 is exemplarily arranged on one side of the light-emitting surface 140a of the diffusion plate 140. Light from the light sources 120 is diffused by the diffusion plate 140 and then emitted. The light passing through the diffusion plate 140 is emitted from the transparent regions 132 of the pattern 130, and other parts of the light may be blocked by the pattern 130, and thus may have reduced brightness or may encounter a color change.

Besides, the difference between the transparent plate 260 and the diffusion plate 140 rests in that the transparency of the diffusion plate 140 is lower than that of the transparent plate 260. Hence, the arrangement of the diffusion plate 140 on the T-bar lamp 200 softens the light and avoids the glare. However, the invention is not limited thereto, and the T-bar lamp 200 may have no diffusion plate 140.

As described in the previous embodiment, the pattern 130 is disposed on the transparent plate 260, such that the transparent regions 132 of the pattern 130 expose the corresponding light sources 120. Through the light that is emitted from the light sources 120 and passes through the transparent regions 132, the light sources 120 may equip the T-bar lamp 200 with the illumination function; other parts of the light may be blocked by the pattern 130, and thus may have reduced brightness or may encounter a color change. Since the material and the color of the pattern 130 may be adjusted according to the actual requirements, favorable ornamentality of the T-bar lamp 200 may be guaranteed.

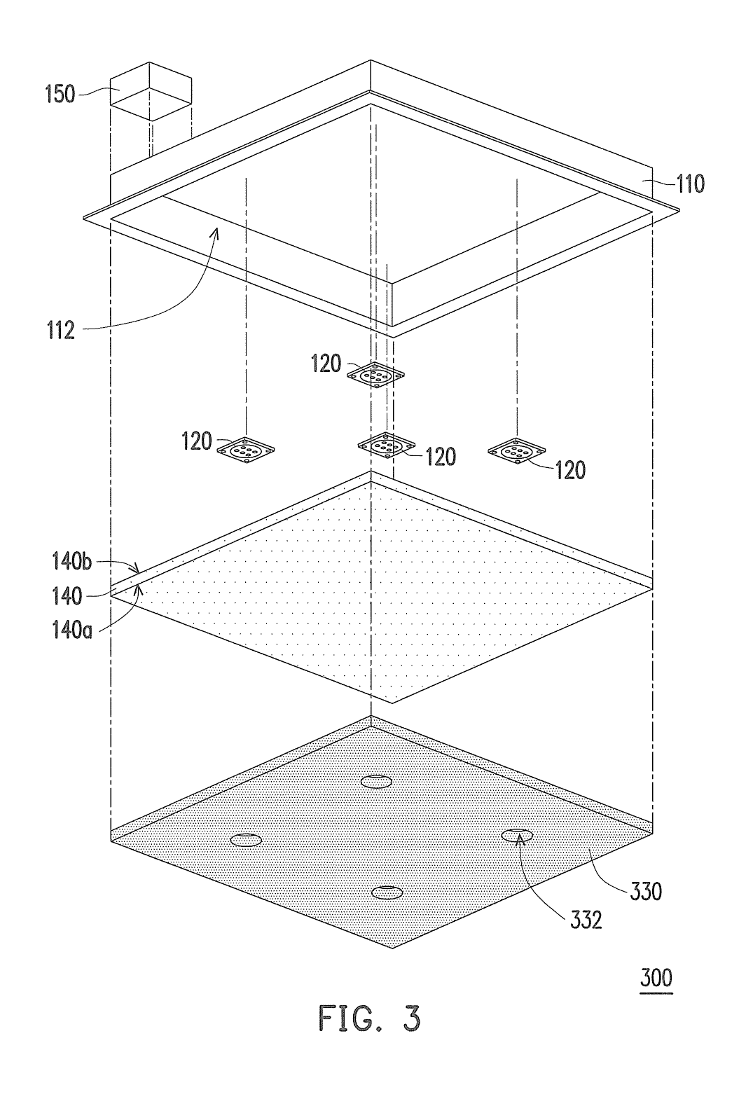

FIG. 3 is an exploded view illustrating a T-bar lamp according to a third embodiment of the invention.

With reference to FIG. 2 and FIG. 3, components of the T-bar lamp 300 similar to those of the T-bar lamp 200 depicted in FIG. 2 are represented by the same reference numbers, are made of similar materials through performing similar processes, and have similar materials, arrangements, and effects; therefore, the similarities of the T-bar lamp 300 and the T-bar lamp 200 will not be further explained hereinafter. The difference between the T-bar lamp 300 and the T-bar lamp 200 will be explained hereinafter. Here, the difference between the T-bar lamp 300 and the T-bar lamp 200 lies in that the pattern 130 of the T-bar lamp 200 is located on the transparent plate 260. Nonetheless, a non-transparent plate acting as the pattern 330 is employed in the T-bar lamp 300 to replace the transparent plate 260 and the pattern 130 on the transparent plate 260 in the T-bar lamp 200. That is, the non-transparent plate itself may serve as the pattern 330, and it is not necessary to additionally print or adhere other patterns onto the non-transparent plate. Therefore, the pattern 330 may be non-transparent and may have color; in other embodiments of the invention, however, the pattern 330 may also have a decorative design, which should not be construed as a limitation to the invention.

The non-transparent plate is, for instance, an aluminum plate or a wooden plate; hence, the light emitted from the light sources 120 is unable to pass through the non-transparent plate. However, the material of the non-transparent plate is not limited in the invention. The non-transparent plate acting as the pattern 330 has at least one hollow region, and the hollow regions serve as the transparent regions 332 of the pattern 330. Thereby, one portion of the light from the light sources 120 is emitted from the transparent regions 332 of the pattern 330, whereas the other portion of the light is blocked by the pattern 330.

As described in the previous embodiment, the non-transparent plate acting as the pattern 330 has the hollow regions as the transparent regions 332, such that the transparent regions 332 of the pattern 330 expose the corresponding light sources 120. Through the light that is emitted from the light sources 120 and passes through the transparent regions 332, the light sources 120 may equip the T-bar lamp 300 with the illumination function; other parts of the light may be blocked by the pattern 330. Since the material and the color of the pattern 330 may be adjusted according to the actual requirements, favorable ornamentality of the T-bar lamp 300 may be guaranteed.

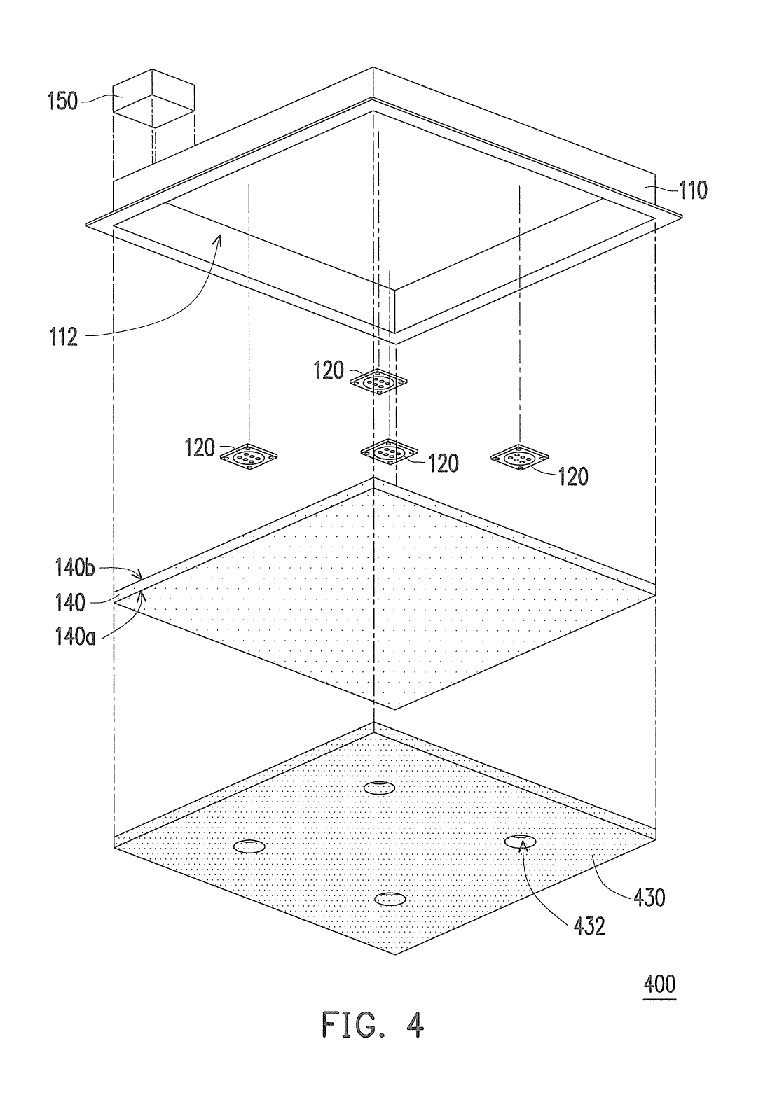

FIG. 4 is an exploded view illustrating a T-bar lamp according to a fourth embodiment of the invention.

With reference to FIG. 3 and FIG. 4, components of the T-bar lamp 400 similar to those of the T-bar lamp 300 depicted in FIG. 3 are represented by the same reference numbers, are made of similar materials through performing similar processes, and have similar materials, arrangements, and effects; therefore, the similarities of the T-bar lamp 400 and the T-bar lamp 300 will not be further explained hereinafter. The difference between the T-bar lamp 400 and the T-bar lamp 300 will be explained hereinafter. Here, the difference between the T-bar lamp 400 and the T-bar lamp 300 lies in that the T-bar lamp 300 employs the non-transparent plate as the pattern 330. By contrast, the T-bar lamp 400 employs a transparent plate as the pattern 430. That is, the transparent plate itself may serve as the pattern 430, and it is not necessary to additionally print or adhere other patterns onto the transparent plate. Therefore, the pattern 430 may be transparent and may have color; in other embodiments of the invention, however, the pattern 430 may also have a decorative design, which should not be construed as a limitation to the invention.

The transparent plate acting as the pattern 430 and the transparent plate 260 described in the second embodiment may be made of similar materials and may have similar properties. For instance, the transparent plate acting as the pattern 430 may be a transparent acrylic board with color, while the invention is not limited thereto. Specifically, the transparent plate acting as the pattern 430 has at least one hollow region, and the hollow regions serve as the transparent regions 432 of the pattern 430. Thereby, one portion of the light from the light sources 120 is emitted from the transparent regions 432 of the pattern 430, whereas the other portion of the light may be blocked by the pattern 430, and thus may have reduced brightness or may encounter a color change.

As described in the previous embodiment, the transparent plate acting as the pattern 430 has the hollow regions as the transparent regions 432, such that the transparent regions 432 of the pattern 430 expose the corresponding light sources 120. Through the light that is emitted from the light sources 120 and passes through the transparent regions 432, the light sources 120 may equip the T-bar lamp 400 with the illumination function; other parts of the light may be blocked by the pattern 430, and thus may have reduced brightness or may encounter a color change. Since the material and the color of the pattern 430 may be adjusted according to the actual requirements, favorable ornamentality of the T-bar lamp 400 may be guaranteed.

To sum up, the T-bar lamp described in the previous embodiments at least has the following properties. Since the T-bar lamp described above has the pattern, and the material and the color of the pattern may be determined according to actual requirements, favorable ornamentality of the T-bar lamp provided in the previous embodiments may be ensured.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A T-bar lamp comprising:
a T-bar lamp housing having an opening;
at least one light source mounted in the T-bar lamp housing; and
a pattern covering the opening and having at least one transparent region, wherein the at least one transparent region exposes the at least one light source corresponding to the at least one transparent region.

2. The T-bar lamp as recited in claim 1, further comprising a diffusion plate disposed on the T-bar lamp housing, wherein the diffusion plate covers the opening, and the pattern is disposed on the diffusion plate.

3. The T-bar lamp as recited in claim 2, wherein the pattern is disposed on the diffusion plate through printing or adhesion.

4. The T-bar lamp as recited claim 2, wherein a material of the diffusion plate comprises a combination of diffusion particles and polystyrene, polycarbonate, or polymethyl methacrylate.

5. The T-bar lamp as recited in claim 1, further comprising a transparent plate disposed on the T-bar lamp housing, wherein the pattern is disposed on the transparent plate.

6. The T-bar lamp as recited in claim 5, wherein the pattern is disposed on the transparent plate through printing or adhesion.

7. The T-bar lamp as recited claim 5, wherein a material of the transparent plate comprises polystyrene, polycarbonate, or polymethyl methacrylate.

8. The T-bar lamp as recited claim 1, wherein the pattern comprises a non-transparent plate, and the non-transparent plate has at least one hollow region as the at least one transparent region.

9. The T-bar lamp as recited claim 8, wherein the non-transparent plate comprises an aluminum plate or a wooden plate.

10. The T-bar lamp as recited claim 1, wherein the at least one light source comprises a light-emitting diode lamp, a fluorescent lamp, or an incandescent lamp.

11. The T-bar lamp as recited claim 1, wherein the pattern comprises a transparent plate, and the transparent plate has at least one hollow region as the at least one transparent region.

12. The T-bar lamp as recited claim 11, wherein the transparent plate has color.
